(19) United States
(12) Patent Application Publication
(10) Pub. No.: US 2026/0255013 A1
(43) Pub. Date: Aug. 27, 2026

(54) HDMI AI Smart TV Module

(71) Applicants: D'Anwar LeMon Hardeman, Richmond, TX (US); Ulerick Donnel Fields, Houston, TX (US); James Mathew Douglas, Houston, TX (US); Milton Earl Douglas, Houston, TX (US)

(72) Inventors: D'Anwar LeMon Hardeman, Richmond, TX (US); Ulerick Donnel Fields, Houston, TX (US); James Mathew Douglas, Houston, TX (US); Milton Earl Douglas, Houston, TX (US)

(21) Appl. No.: 19/551,439

(22) Filed: Feb. 26, 2026

Related U.S. Application Data
(60) Provisional application No. 63/763,399, filed on Feb. 26, 2025.

(51) Int. Cl. H04N 21/4415; G06F 21/32; H04N 21/4363; H04N 21/454; H04N 21/475

(52) U.S. Cl. CPC H04N 21/4415; G06F 21/32; H04N 21/43635; H04N 21/4542; H04N 21/4751; H04N 21/4755

(57) ABSTRACT

An HDMI-based artificial intelligence (AI) module is disclosed for enhancing smart televisions and other HDMI-compatible devices with advanced interactive capabilities. The module connects to a television through an HDMI interface and incorporates a microphone, a camera, and wireless connectivity to enable voice recognition, facial recognition, biometric authentication, and automated parental control functions. An integrated AI operating system allows users to control television functions through voice commands, receive personalized content, and automatically log in based on detected user identity. The system further enables AI-generated content creation, including simulated channels, short films, and interactive applications downloadable through an integrated App Store. The module synchronizes data, applications, and user activity across multiple devices within a home network, including televisions, computers, tablets, and gaming systems. The invention provides a comprehensive upgrade to existing smart TVs by adding AI-driven personalization, security, entertainment creation, and multi-device connectivity.

The current application claims a priority to the U.S. Provisional Patent application Ser. No. 63/763,399 filed on Feb. 26, 2025.

### FIELD OF THE INVENTION

The present invention relates to the integration of artificial intelligence (AI) technology into television systems. More specifically, the present invention relates to an HDMI AI smart TV module that enhances the functionality of smart TVs and other HDMI-compatible devices by incorporating AI features.

### BACKGROUND OF THE INVENTION

With the rapid advancement of AI technology, there is a growing demand for integrating AI capabilities into everyday devices to enhance user experience and interaction. Traditional smart TVs offer limited functionalities and often require multiple devices to achieve a comprehensive smart home setup. The present invention addresses these limitations by providing an all-in-one AI module that connects to a TV via HDMI, offering a wide range of AI-driven features.

### SUMMARY OF THE INVENTION

The HDMI AI TV Module is a device that connects to a TV's HDMI port, delivering AI features to the TV. The module includes a microphone and a camera extension, enabling voice and facial recognition capabilities. The module also features Wi-Fi connectivity, allowing it to interface with smart TVs and other HDMI-compatible devices.

### BRIEF DESCRIPTION OF THE DRAWINGS

FIG. 1 shows a TV and the module of the present invention which connects to the TV via the HDMI ports.

FIG. 2 shows the HDMI cable being inserted into a smart TV.

FIG. 3 shows the camera and microphone of the present invention.

FIG. 4 is an example of a home screen where the user can select a personal profile.

### DETAILED DESCRIPTION OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of an HDMI AI Smart TV Module, embodiments of the present disclosure are not limited to use only in this context.

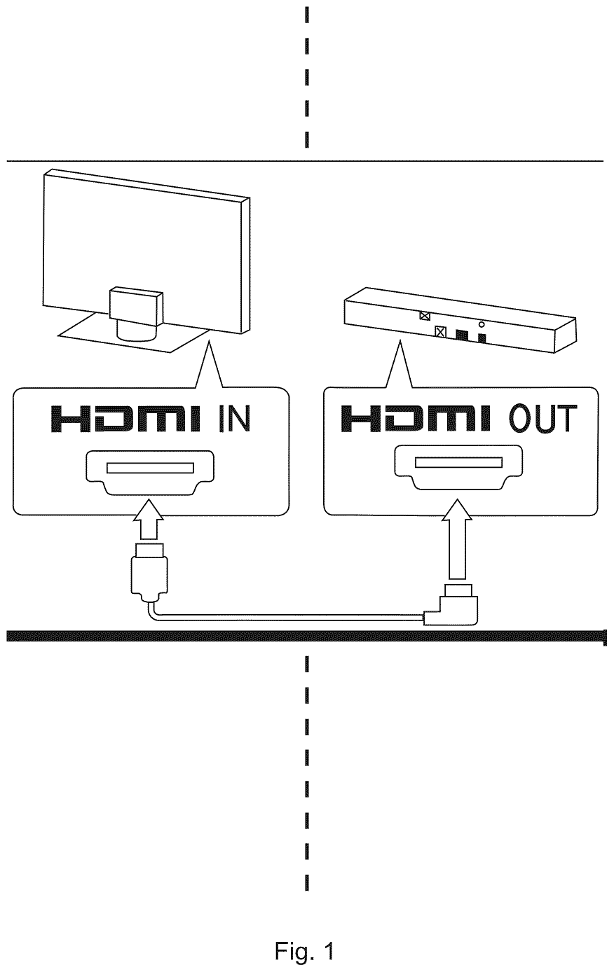

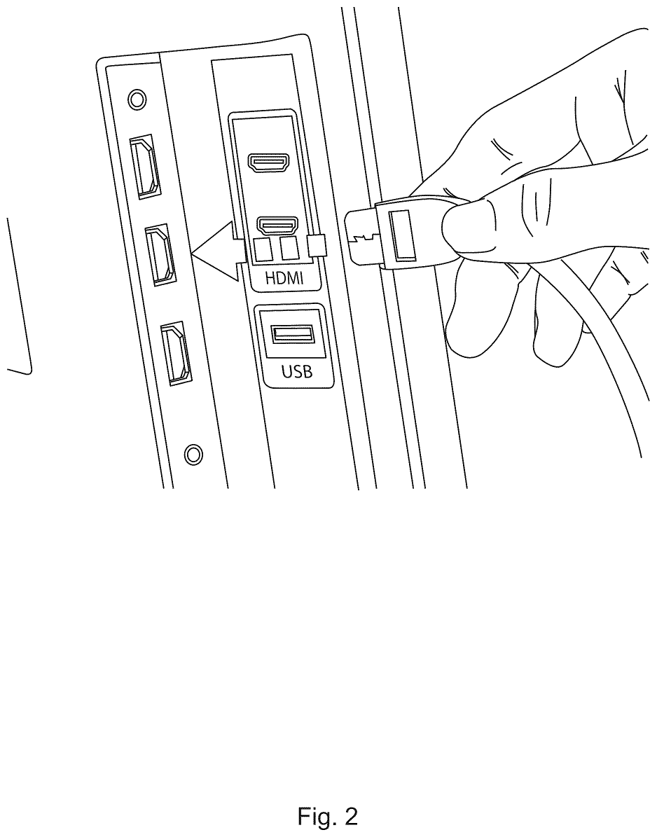

The present invention relates to the integration of artificial intelligence (AI) technology into television systems, specifically through an HDMI AI TV Module that enhances the functionality of smart TVs and other HDMI-compatible devices. This module connects to a TV's HDMI port and includes a microphone and camera extension, enabling voice and facial recognition capabilities. With Wi-Fi connectivity, the module interfaces with smart TVs and other HDMI-compatible devices, providing a seamless user experience. FIG. 1 and FIG. 2 show an example of how a module could connect to a TV via an HDMI cable.

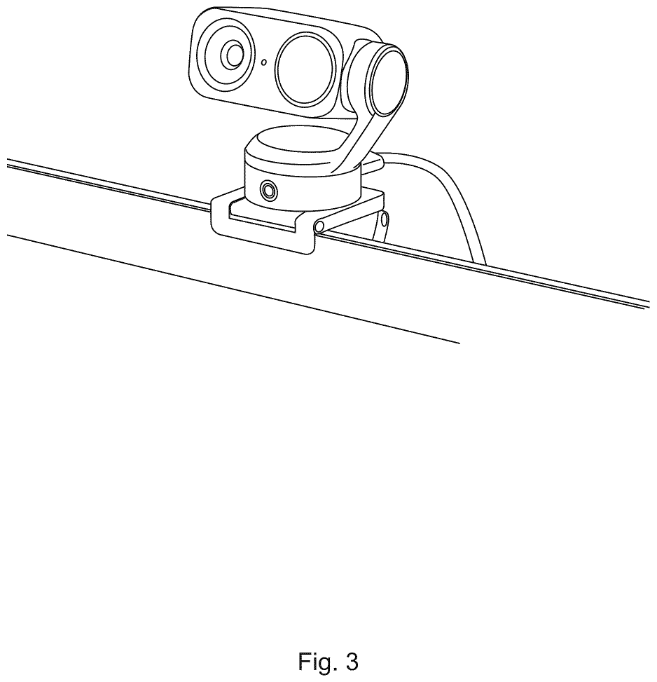

The module's hardware configuration includes HDMI connectivity for easy integration with the TV's input/output system, a built-in microphone for capturing voice commands, and a camera for biometric facial recognition. FIG. 3 shows a camera and microphone of the present invention. The software configuration features a unique AI operating system that allows users to control smart TV functionalities through voice commands and other intuitive interactions. The camera and microphone work together to recognize users and log them in automatically, providing a personalized experience. The camera and microphone further enable automatic parental controls. A user may specify certain types of content with which they do not want their children to interact. If the camera recognizes a child in front of the TV, it may prevent the child from changing to a TV channel featuring a show or movie with a certain rating such as R or TV-14. It may prevent explicit songs from being played through a music app and may also prevent the child from playing certain video games. The present invention removes the need to set and turn off these parental controls manually. The present invention will automatically know whether the parental controls need to be active based on who is in front of the TV. The AI module may further be used to control screen time. The user may allow a child a certain amount of screen time, and the module will turn off automatically when the child has been in front of the screen for more than the approved amount of time.

The present invention has the ability to generate AI-driven content, including an AI channel that creates imaginary content through AI simulation. The integrated App Store allows users to download and install new apps, expanding the module's capabilities. Users can control the TV and access various features using voice commands, stream content from basic channels, world news, creative content channels, and live TV streaming, and engage in interactive activities such as document viewing and reading (audio/avatar) and AI-generated content creation.

The module also includes biometric facial scanning for secure user authentication and allows users to create AI short films, movies, and other content using compatible apps from the App Store. Further apps may include AI templates to show different looks, such as outfits, hairstyles, and interfaces. A user's AI template may show up on screen when someone calls. Social media integration enables users to upload comments, likes, and dislikes to social media platforms for reviews on AI-generated content. The module upgrades existing smart TVs and HDMI devices with AI capabilities, making them more interactive and user-friendly, and enables the creation of AI broadcasting channels and television stations.

The present invention may comprise synchronization and connectivity between different devices throughout a home, such as TVs, computers, and tablets over a Wi-Fi network. The invention may further comprise gaming apps, wherein game progress and data syncs between different devices. Conversations and messages may also be synchronized.

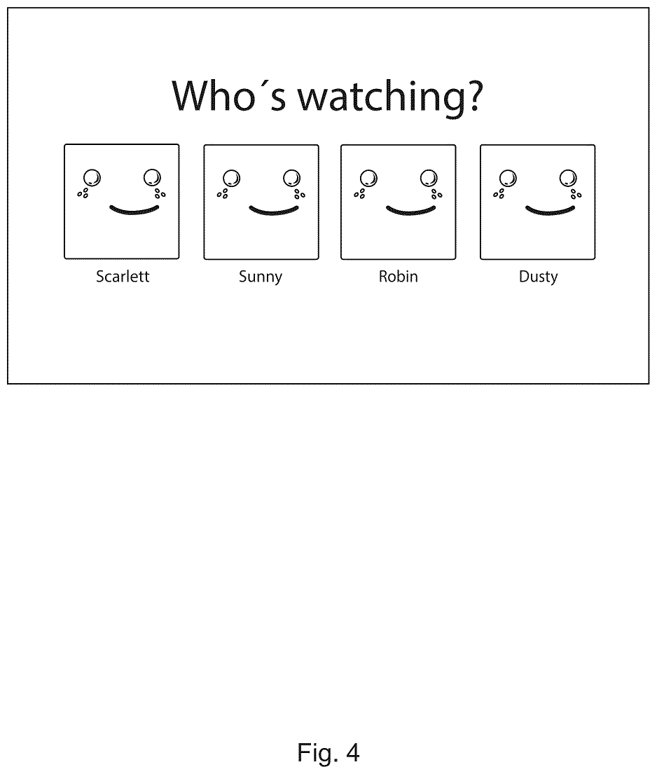

Overall, the present invention offers enhanced user experience through hands-free, intuitive interaction with the TV, comprehensive functionality by combining multiple features into a single device, personalization through biometric scanning and user authentication, and expanded possibilities for home entertainment through AI content creation and sharing. This invention represents a significant advancement in the integration of AI technology into television systems, providing a comprehensive solution for enhancing smart TV functionalities and user interaction. FIG. 4 shows an example of a log-in screen with different user profiles.

Although the invention has been explained in relation to its preferred embodiment, it is to be understood that many other possible modifications and variations can be made without departing from the spirit and scope of the invention.

What is claimed is:

1. An artificial intelligence television module, comprising;
an HDMI connector configured to interface with a television or other HDMI-compatible device;
a microphone configured to receive voice input from a user;
a camera configured to capture facial imagery of the user;
a wireless communication interface configured to connect the module to a network; and an artificial intelligence operating system stored in memory and executed by a processor, wherein the artificial intelligence operating system is configured to,
process the voice input to control one or more functions of the television;
perform facial recognition using the camera to authenticate a user; and
automatically apply personalized settings or restrictions based on the authenticated user.

2. The module of claim 1, wherein the personalized settings comprise automatic parental controls that restrict access to content based on the identity or age classification of the detected user.

3. The module of claim 2, wherein the parental controls prevent a child from accessing television channels, movies, music, or video games exceeding a predetermined content rating.

4. The module of claim 2, wherein the parental controls further include automatic screen-time enforcement, wherein the module disables the television after a child exceeds an allotted viewing duration.

5. The module of claim 1, wherein the artificial intelligence operating system is further configured to generate AI-simulated content, including an AI-generated television channel.

6. The module of claim 1, further comprising an App Store interface enabling installation of third-party or proprietary applications that extend the module's functionality.

7. The module of claim 6, wherein the applications include AI content creation tools for generating short films, movies, or interactive media.

8. The module of claim 6, wherein the applications include AI template tools for generating virtual outfits, hairstyles, or user interface themes.

9. The module of claim 1, wherein the artificial intelligence operating system is configured to display a personalized avatar or AI template when a user receives a call or communication.

10. The module of claim 1, wherein the wireless communication interface enables synchronization of user data, messages, and application states across multiple devices within a home network, including televisions, computers, tablets, and gaming systems.

11. A method for enhancing a television with artificial intelligence functionality, comprising;
connecting an AI module to a television through an HDMI interface;
receiving voice input through a microphone of the module;
capturing facial imagery through a camera of the module;
performing voice recognition to control television functions;
performing facial recognition to authenticate a user; and
automatically applying personalized settings or restrictions based on the authenticated user.

12. The method of claim 11, further comprising automatically enabling parental controls when the authenticated user is identified as a child.

13. The method of claim 11, further comprising preventing playback of restricted content when a child is detected in front of the television.

14. The method of claim 11, further comprising tracking the duration of time a child is present and disabling the television when a screen-time limit is exceeded.

15. The method of claim 11, further comprising generating AI-created content for display on the television.

16. The method of claim 11, further comprising downloading applications from an App Store accessible through the AI module.

17. The method of claim 11, further comprising synchronizing user profiles, application data, and media progress across multiple devices connected to a shared wireless network.

18. The method of claim 11, further comprising enabling social media interaction, including uploading comments, likes, or reviews related to AI-generated content.

19. The method of claim 11, further comprising automatically logging a user into a personalized profile upon successful facial recognition.

20. The method of claim 11, further comprising enabling voice-controlled navigation of streaming services, live television channels, creative content channels, or interactive reading and document-viewing applications.
